(19) United States
(12) Patent Application Publication
(10) Pub. No.: US 2025/0392492 A1
(43) Pub. Date: Dec. 25, 2025

(54) Method for Operating Multiple Electronic Modules of a Vehicle, Vehicle Communication System, and Computer Program Product

(71) Applicant: Robert Bosch GmbH, Stuttgart (DE)

(72) Inventors: Xiaofei Qiu, Suzhou (CN); David Voigt, Bietigheim-Bissingen (DE)

(21) Appl. No.: 19/238,908

(22) Filed: Jun. 16, 2025

(30) Foreign Application Priority Data
Jun. 21, 2024 (CN) 2024 1080 9118.2

(51) Int. Cl. H04L 12/40

(52) U.S. Cl. CPC H04L 12/40176; H04L 12/40032; H04L 12/40045; H04L 2012/40215; H04L 2012/40273

(57) ABSTRACT

A method for operating a plurality of electronic modules of a vehicle is disclosed. The plurality of electronic modules are connected to a vehicle data bus for communication and the plurality of electronic modules are connected to a power cable for power. The method includes (1) transmitting first information from a first electronic module of a plurality of electronic modules through a vehicle data bus to a second electronic module, (ii) transmitting second information from a first electronic module through a power cable to a second electronic module, the second information including redundant information of the first information or negated information of the first information, and (iii) at the second electronic module, operating the second electronic module based on the first information obtained from the vehicle data bus and/or the second information obtained from the power cable. An in-vehicle communication system and a computer program product are also disclosed.

This application claims priority under 35 U.S.C. § 119 to application no. CN 2024 1080 9118.2, filed on Jun. 21, 2024 in China, the disclosure of which is incorporated herein by reference in its entirety.

The present disclosure relates to a method for operating a plurality of electronic modules of a vehicle and further relates to an in-vehicle communication system and a computer program product.

### BACKGROUND

As some functions related to vehicle safety (e.g., the airbag disable switch) are gradually made electronic, higher requirements are put forward for the reliability of the communication and information security of various components inside the vehicle.

Under the current in-vehicle communication architecture, the various electronic modules of the vehicle are connected to each other via a single data bus to achieve information transmission. However, if the data bus is disconnected, the information instructions will not be able to reach the target node on the bus, resulting in loss of function of the vehicle and even major safety issues.

In some known solutions, it is proposed to set up a dual-channel bus in the vehicle to transmit redundant communication data through an additional bus, but this approach is costly and difficult to implement.

In this context, it is desirable to provide an improved vehicle internal communication solution to improve the reliability of communication of the various components of the vehicle at a controllable cost.

### SUMMARY

It is an aim of the present disclosure to provide a method for operating a plurality of electronic modules of a vehicle, an in-vehicle communication system, and a computer program product to address at least some of the problems in the prior art.

According to a first aspect of the present disclosure, a method is provided for operating a plurality of electronic modules of a vehicle, wherein the plurality of electronic modules are connected to a vehicle data bus for communication and the plurality of electronic modules are connected to a power cable for power, the method comprising the steps of:
transmitting first information from a first electronic module of a plurality of electronic modules through a vehicle data bus to a second electronic module;
transmitting second information from a first electronic module through a power cable to a second electronic module, the second information including redundant information of the first information or negated information of the first information; and
at the second electronic module, operating the second electronic module based on the first information obtained from the vehicle data bus and/or the second information obtained from the power cable.

The present disclosure includes the following technical concepts: in the proposed method, there is no need to add an additional vehicle data bus to the existing communication architecture as the communication capacity of the power cable is fully utilized. Thus, redundant information transmission between the various electronic components of the vehicle is achieved without significantly increasing hardware costs. In particular, it is advantageous for safety-related functions. In case of failure of one channel, another channel can assume the communication tasks of the failed channel in a timely manner, allowing the target node to clearly know the status of the relevant function instructions so that the safety function can be ensured without interruption. Overall, the provision of reliable information backup capabilities for the vehicle increases the level of safety of vehicle systems.

According to a second aspect of the present disclosure, an in-vehicle communication system is provided, comprising:
a vehicle data bus;
a power cable; and
a plurality of electronic modules operating according to the method according to the first aspect of the present disclosure.

According to a third aspect of the present disclosure, a computer program product having a program code unit configured to cause the computer to implement the method according to the first aspect of the present disclosure when the computer program product is running on a computer or stored on a computer-readable storage medium is provided.

### BRIEF DESCRIPTION OF THE DRAWINGS

In the following, the present disclosure is described in greater detail with reference to the accompanying drawings to provide a better understanding of its principles, features, and advantages. The accompanying drawings include the following:

FIG. 1a and FIG. 1b show structural block diagrams of an in-vehicle communication system according to an exemplary example of the present disclosure;

FIG. 2 shows a structural block diagram of a power cable sending unit and power cable receiving unit in an electronic module according to an exemplary example of the present disclosure;

FIG. 3 shows a flow chart of a method of operating a plurality of electronic modules of a vehicle according to an exemplary example of the present disclosure;

FIG. 4 shows a flow chart of a method for operating a plurality of electronic modules of a vehicle according to another exemplary example of the present disclosure;

FIG. 5 shows a communication timing diagram of the transmission of first information through a vehicle data bus and a power cable, respectively, according to an exemplary example of the present disclosure; and

FIGS. 6a-6e show schematic diagrams of using the method according to the present disclosure in exemplary application scenarios.

### DETAILED DESCRIPTION

To provide a clearer understanding of the technical problems, technical solutions, and beneficial technical effects to be addressed by the present disclosure, the following detailed description of the present disclosure will be provided with reference to the accompanying drawings and multiple exemplary examples. It should be understood that the specific examples described herein are provided solely for the purpose of explaining the present disclosure and not for limiting the scope of protection of the present disclosure.

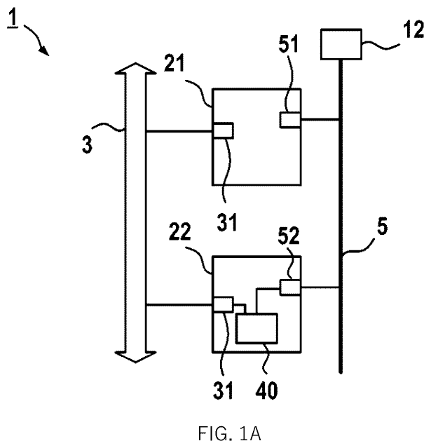

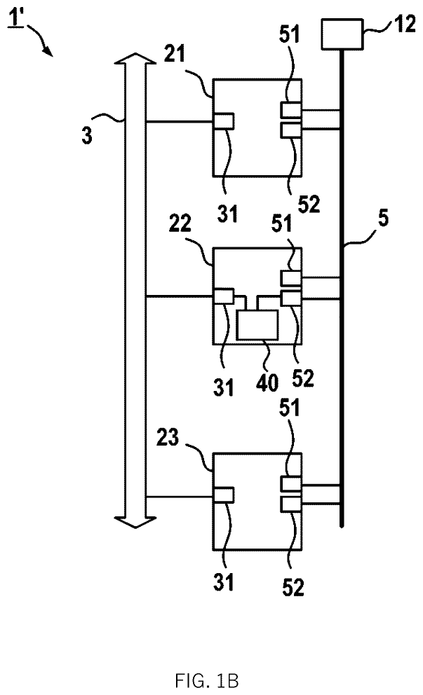

FIG. 1a and FIG. 1b show structural block diagrams of an in-vehicle communication system according to an exemplary example of the present disclosure.

As shown in FIG. 1a, the in-vehicle communication system 1 is mounted on a vehicle and includes a vehicle data bus 3, a power cable 5, and a plurality of electronic modules 21 and 22. Here, these electronic modules 21 and 22 relate to, for example, an electronic control unit (ECU) of the vehicle, which is used to control specific functions or systems of the vehicle, including, for example, an airbag electronic control unit, a brake system electronic control unit, and an air conditioning electronic control unit. In addition, the electronic modules 21 and 22 may also relate to a domain controller of the vehicle, which has the functions of a plurality of electronic control units and coordinates the interaction between the various electronic control units by processing and distributing data to achieve comprehensive control of the entire vehicle system.

By way of example, the first and second electronic modules 21 and 22 of the plurality of electronic modules 21 and 22 are shown in FIG. 1a. The first and second electronic modules 21 and 22 are respectively connected to the vehicle data bus 3 via the bus communication unit 31 for communication. The vehicle data bus 3 includes, for example, a CAN bus (controller area network), a LIN bus (local interconnect network, a MOST bus (media oriented systems transport, and a FlexRay bus. The first and second electronic modules 21 and 22, respectively, are also connected to the power cable 5, through which the first and second electronic modules 21 and 22 are connected to the power source (e.g., a battery) 12 to power them. Additionally, in the in-vehicle communication system 1, the power cable 5 also serves as a communication medium to at least partially facilitate communication between the first electronic module 21 and the second electronic module 22. To this end, the first electronic module 21 comprises, for example, a power cable sending unit 51 for loading a communication signal onto the power cable 5. The second electronic module 22 comprises, for example, a power cable receiving unit 52 for receiving a communication signal from the power cable 5. Additionally, the second electronic module 22 further comprises a control unit 40 to analyze and process the communication signals received from the vehicle data bus 3 and power cable 5 and to operate the second electronic module 22 based on the results of the analysis and processing. Here, the corresponding power cable sending unit 51 and power cable receiving unit 52 may be selectively turned off, for example, so that the electronic modules 21 and 22 may communicate via the power cable 5 only when necessary, while only being powered by the power cable 5 at other times.

Specifically, the first electronic module 21 may transmit the first information to the vehicle data bus 3 via the bus communication unit 31. The first electronic module 21 may also transmit second information to the power cable 5 via the power cable sending unit 51, the second information including redundant information or negated information of the first information. Accordingly, the second electronic module 22 can obtain the first information from the vehicle data bus 3 via the bus communication unit 31 and the second information from the power cable 5 via the power cable receiving unit 52. In the second electronic module 22, the second electronic module 22 is operated by way of the control unit 40 based on the first information obtained from the vehicle data bus 3 and/or the second information obtained from the power cable 5.

In one example, the first electronic module 21 relates to an airbag electronic control unit. The second electronic module 22 relates to a display electronic control unit. The display electronic control unit is used, for example, to control one or more in-vehicle display units such as a central control screen, a head-up display HUD, electronic instruments, a co-pilot/rear entertainment display, etc. and to receive instructions input by a user from the corresponding in-vehicle display units.

Generally, the airbag electronic control unit is used to control the deployment of airbags when a collision is detected to reduce the degree of injury to the occupants. However, if a particular seat is unoccupied, deploying the corresponding airbag for that seat would result in waste and high reinstallation costs. In addition, if a child is held in the front passenger seat, the default activated airbag would be unsafe for them. Thus, the possibility of disabling/disarming the airbag is provided for the occupants by the installation of an airbag disable switch (PADS, passenger airbag disable switch) in the vehicle.

Traditionally, the airbag disable switch is constructed as a mechanical button or key slot and is located near the driver's instrument panel or on the passenger side. However, with the advancement of vehicle electronics, such physical switches are gradually being replaced by software switches (such as virtual buttons and/or virtual knobs on the vehicle display unit). When the power is turned on, the occupants may trigger the original airbag disable function by operating the software switch on the vehicle's central control screen. The display electronic control unit then receives and sends an security airbag disable instruction to the airbag electronic control unit in the form of an electrical signal. Accordingly, the airbag electronic control unit may disable the armed state of the airbag in response to the received airbag disable instruction.

FIG. 1b shows a structural block diagram of an in-vehicle communication system 1′ according to another example of the present disclosure.

The main difference between the examples shown in FIG. 1b and FIG. 1a is that: the first electronic module 21 and the second electronic 22 each include a power cable sending unit 51 and a power cable receiving unit 52, which allow each of them not only to load communication signals to the power cable 5, but also to receive communication signals from the power cable 5. For each of the electronic modules 21 and 22, the power cable sending unit 51 and the power cable receiving unit 52 may be implemented separately or integrated (e.g., they may share some functional components). In addition, a third electronic module 23 is also shown in FIG. 1b, which also comprises, for example, a power cable sending unit 51 and a power cable receiving unit 52, such that the first electronic module 21 can not only send a communication signal to the second electronic module 22 through the power cable 5, but can also send a communication signal to the third electronic module 23.

In particular, the first electronic module 21 may transmit the second information to the second electronic module 22 through the power cable 5, while the first electronic module 21 may transmit fourth information to the third electronic module 23 through the power cable 5, either at the same time or successively. On the power cable 5, the second information is transmitted bound with the communication address of the second electronic module 22 and the fourth information is transmitted bound with the communication address of the third electronic module 23. Accordingly, the second electronic module 22 and the third electronic module 23 each receive the second information and the fourth information from the power cable 5 and then distinguish which information is directed to themselves according to the communication address and respectively execute only the information bound to the transmission of their own communication address.

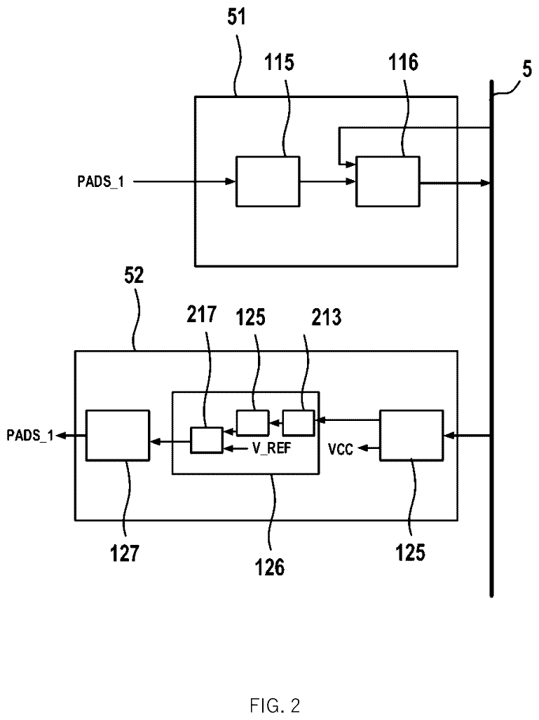

FIG. 2 shows a structural block diagram of a power cable sending unit 51 and power cable receiving unit 52 in an electronic module according to an exemplary example of the present disclosure.

The power cable sending unit 51 and power cable receiving unit 52 shown in FIGS. 1a and 1b are illustrated in a more detailed manner in FIG. 2.

The power cable sending unit 51 comprises, for example, a modulation/encoding unit 115 and a coupling unit 116 connected to one another. In this example, the second information to be transmitted is exemplarily shown in the form of a trigger signal (i.e., e.g., an airbag disable instruction) PAD_1 of the airbag disable switch.

The modulation/encoding unit 115 is used to convert the second information PAD_1 into a communication signal carrying the second information PAD_1 and suitable for transmission on the power cable 5 by a modulation/encoding operation and output the communication signal to the coupling unit 116. Here, modulation/encoding techniques that can be employed include frequency modulation, amplitude modulation, phase modulation, pulse width modulation (PWM), pulse code modulation (PCM), and differential code modulation (DCM), among others. In practical applications, appropriate modulation and encoding technology can be selected according to specific communication requirements and environmental conditions. In a specific embodiment, a high-frequency pulse signal carrying the second information PAD_1 may be loaded onto a current to form a high-frequency pulse current signal. The frequency of the high-frequency pulse current signal is, for example, several hundred kilohertz to several megahertz.

The coupling unit 116 is used to couple the communication signal carrying the second information PAD_1 with the power supply signal on the power cable 5 and load it on the power cable 5 for transmission. By adjusting the parameter configuration of the coupling unit 116 (e.g., gain and/or frequency response), the communication signal shared the same transmission channel 5 as the power supply signal, thereby ensuring that the communication signal generated by the modulation/encoding unit 115 is effectively injected onto the vehicle power cable 5.

Accordingly, the power cable receiving unit 52 includes, for example, a decoupling unit 125 and a demodulation/decoding unit 127. A signal processing unit 126, for example, is optionally also connected between them, comprising, for example, a filter 213, amplifier 215, and comparator 217 connected in series. The decoupling unit 125 is used to receive signals from the power cable 5 and separate the communication signal from the power supply signal VCC in the received signals by a decoupling operation. The separated power supply signal VCC is provided, for example, for powering the second electronic module 22. The separated communication signal is output to the signal processing unit 126. There, the communication signal is first filtered by the filter 213 and amplified by the amplifier 215 to remove noise and enhance signal strength to ensure the quality and stability of the received communication signal. The signal output by the amplifier 215 is provided to the comparator 217, which compares the signal output by the amplifier 215 to a preset reference signal V_REF to make a “high” or “low” judgment. Thus, the analog signal is converted into a digital signal for subsequent digital signal processing. The demodulation/decoding unit 127 is responsible for converting the processed communication signal into a second information PADS_1 by a demodulation/decoding operation. For example, the demodulation/decoding unit 127 resolves the digital signal output by the comparator 217 according to a communication protocol or encoding scheme predefined in the control system, thereby restoring the original control information PADS_1.

In one example, the control information included in the second information is PADS_1 and PADS_0. For example, PADS_1 corresponds to a signal that the airbag disable switch is triggered (i.e., an airbag disable instruction) and PADS_0 corresponds to a signal that the airbag is not triggered (i.e., the initial switch state of the airbag disable switch is “activated”). After the control information is modulated into high-frequency pulse current signals, assuming that 4 pulse bits are transmitted in one cycle, the high-frequency pulse current signal corresponding to the trigger signal is 1010 and the high-frequency pulse current signal corresponding to the non-trigger signal is 0101.

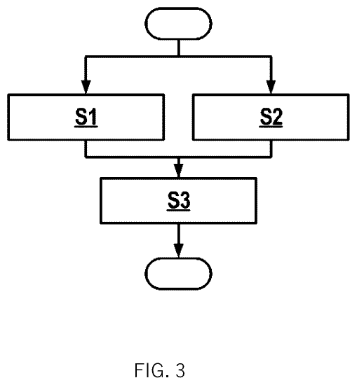

FIG. 3 shows a flow chart of a method for operating a plurality of electronic modules of a vehicle according to an exemplary example of the present disclosure. The method exemplarily includes steps S1-S3, and these steps may be implemented, for example, when using the in-vehicle communication system shown in FIGS. 1a and 1b.

In step S1, first information is transmitted from a first electronic module of a plurality of electronic modules through a vehicle data bus to a second electronic module.

Here, the first information may include control instructions, sensor data, and/or system status information.

In one example, the first electronic module relates to a display electronic control unit of a vehicle, the second electronic module relates to an airbag electronic control unit of the vehicle, and the first information includes that an airbag disable switch is triggered. Exemplarily, the airbag disable switch includes two switch states, for example, “OFF (disabled)” and “ON (activated),” and the user can give an airbag disable instruction or an airbag activation instruction by triggering the switch. Generally, the airbag disable switch is in the “activated” state by default. In the above steps, the display electronic control unit may send the corresponding switch trigger signal as the first information to the vehicle data bus after receiving the user's trigger operation on the airbag disable switch.

In step S2, second information is transmitted from a first electronic module through a power cable to a second electronic module, the second information including redundant information of the first information or negated information of the first information.

The second information includes “redundant information” of the first information, understood as: the second information contains information content that is completely consistent with the first information. That is, if the first information includes that the airbag disable switch is triggered (disable instruction or activation instruction), the second information also includes that the airbag disable switch is triggered (corresponding disable instruction or activation instruction).

The second information includes “negated information” of the first information, understood as: the second information contains information that contradicts or conflicts with the first information. In some cases, the second information may include information that is opposite to the first information. For example, if the first information includes that the airbag disable switch is triggered (i.e., a disable instruction or activation instruction), the second information may include that the airbag disable switch is not triggered (i.e., the original switch state of the switch before being triggered). As another example, if the first information relates to a detection result of an acceleration sensor, the second information may include a different detection result of the acceleration sensor.

To maximize the benefits of the power cable as a parallel communication path, the information contained in the second information can be dynamically adjusted in time. For example, the content of the information contained in the second information can be made dependent on whether the first information is being transmitted via the vehicle data bus.

In one example, during the transmission of the first information from the first electronic module to the second electronic module via the vehicle data bus, the second information transmitted from the first electronic module to the second electronic module via the power cable relates to redundant information of the first information. When the first information from the first electronic module is not transmitted to the second electronic module through the vehicle data bus, the second information transmitted from the first electronic module to the second electronic module through the power cable relates to negated information of the first information.

In one example, the second information may also be transmitted via the power cable only during the transmission of the first information via the vehicle data bus, the second information relating to redundant information of the first information. In other words, the second information is not transmitted via the power cable when the first information is not transmitted via the vehicle data bus.

In one example, transmitting communication signals via the power cable does not affect the normal power supply function of the power cable. To this end, the frequency of the communication signal carrying the second information to be loaded onto the power cable may be suitably selected when transmitting the second information through the power cable so that it is far higher than the frequency of the power supply signal on the power cable. For example, the frequency of the communication signal may be set at a frequency that is higher than the oscillation frequency of the power supply signal on the power cable by a predetermined frequency interval (e.g., at least a few hundred kilohertz or several megahertz). This ensures that the high-frequency pulse signal and the DC power supply signal are clearly distinguished from each other in the spectrum and do not interfere with each other.

In one example, the second information is transmitted from the first electronic module to the second electronic module via the power cable only when the first information includes information related to vehicle safety and/or only when the second electronic module is an electronic module related to vehicle safety. By reducing unnecessary data transmission over the power cable, the amount of data and signal complexity in power cable communication can be reduced, thereby improving system efficiency and responsiveness. In addition, unnecessary electromagnetic compatibility issues can be avoided while reducing interference with normal power supply functions. Exemplarily, information related to vehicle safety includes: sensor data related to the vehicle's driving status and/or vehicle movement (such as the vehicle's speed, steering status, braking status, and/or acceleration status, etc.), collision detection signals, trigger signals of the airbag disable switch, vehicle body stability control signals, and energy status signals (such as fuel level, battery status and/or engine status signals, etc.). Exemplarily, electronic modules related to vehicle safety include: airbag electronic control unit, anti-lock brake control system, electronic stability control system and/or driver assistance control system, etc.

In step S3, at the second electronic module, the second electronic module is operated based on the first information obtained from the vehicle data bus and/or the second information obtained from the power cable.

In this step, for example, whether to operate the second electronic module based on the first information alone, based on the second information alone, or based on the first information and the second information together can be determined based on whether the communication status of the vehicle data bus is abnormal and/or whether the first information can be received from the vehicle data bus.

In this step, “operating the second electronic module” may include: generating, by the second electronic module, a control signal for at least one vehicle component to implement control operations on the vehicle component. Here, the vehicle component may be either an underlying vehicle actuator (such as an airbag) attached to and/or supervised by the second electronic module or another electronic module (such as an electronic instrument of the vehicle).

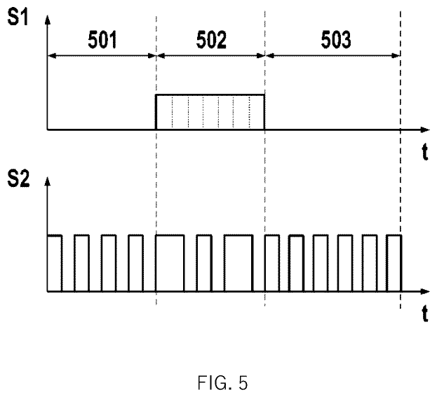

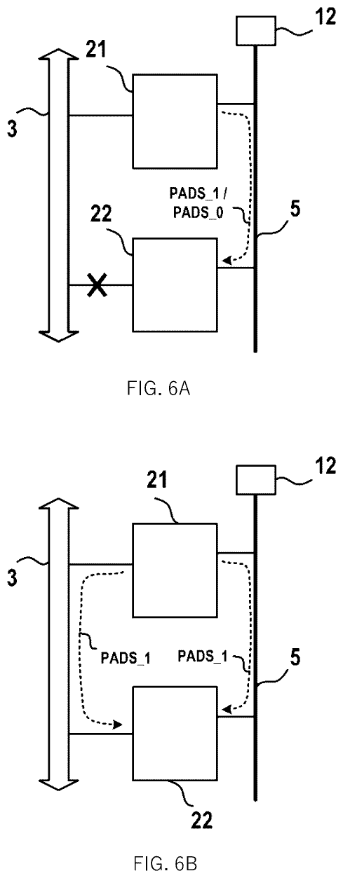

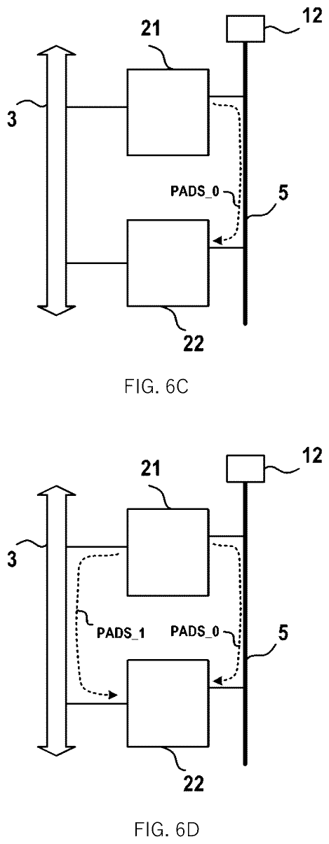

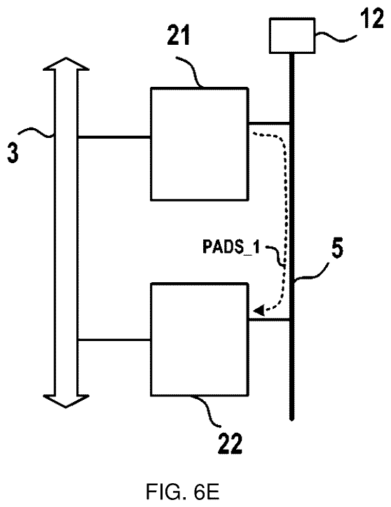

The specific operation of the second electronic module based on the first information obtained from the vehicle data bus and/or the second information obtained from the power cable is set forth below in connection with the example shown in FIGS. 6a-6e, which will not be described in detail here.

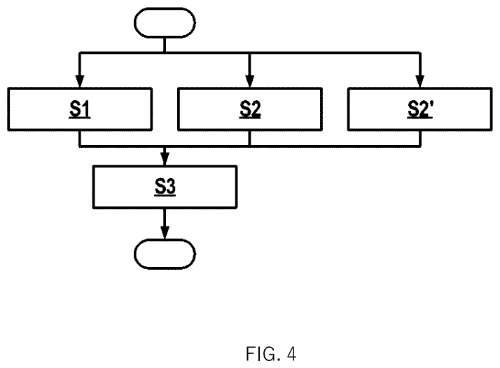

FIG. 4 shows a flow chart of a method of operating a plurality of electronic modules of a vehicle according to another exemplary example of the present disclosure. In the example shown in FIG. 4, the method shown in FIG. 3 further includes an additional step S2′.

In this additional step S2′, third information is also transmitted from the first electronic module to the second electronic module by the power cable, the third information relating to information of a different type than the first information.

In one example, the first information includes that the airbag disable switch is triggered (e.g., a disable instruction) and the third information includes basic occupant information (e.g., height, weight, and/or sitting posture), which can be input by the occupant in the vehicle's central control screen and can be provided for adaptively setting the airbag's pop-out status.

In one example, the first information includes a detection result of a speed sensor of the vehicle and the third information includes a detection result of a gyroscope sensor of the vehicle.

In one example, the transmission of the second information and the third information through the power cable can be achieved by way of the frequency-division multiplexing technique, for example. For example, the communication channel of the power cable may be divided into several sub-bands (sub-channels) and the different information to be transmitted may be modulated to different sub-bands for transmission, thereby ensuring that the communication signals transmitted in each sub-band do not interfere with each other.

It is to be noted that although FIG. 4 shows that step S2 and additional step S2′ are performed in parallel, it should be understood that the transmission of the third information via the power cable can be performed not only in parallel with the transmission of the second information, but also alternately or successively therewith.

FIG. 5 shows a communication timing diagram of the transmission of first information through a vehicle data bus and a power cable, respectively, according to an exemplary example of the present disclosure.

Exemplarily, a communication signal S1 carrying first information transmitted on a vehicle data bus and a communication signal S2 carrying second information transmitted on a power cable are shown over time.

When the user does not trigger the airbag disable switch on the vehicle's central control screen, for example, the passenger-side airbag is in an activated state by default. At this time, no airbag disable instruction in the form of first information is transmitted on the vehicle data bus, which corresponds to the idle periods 501 and 503 on the vehicle data bus. In the idle periods 501 and 503, the second information is also transmitted in parallel via the power cable, where the second information is negated information of the first information. It can be seen that what is transmitted on the power cable is a series of sequences consisting of high-frequency pulses, which represent the untriggered state of the airbag disable switch (i.e., the activated state of the airbag). Exemplarily, different switch states of the airbag disable switch can be encoded into different high-frequency pulse sequences, for example, a high-level pulse represents “1” and a low-level pulse represents “0,” and different pulse sequence combinations can represent different switch states.

When the user changes the switch state of the airbag disable switch from “activated” to “disabled,” the display electronic control unit sends this trigger signal (i.e., the airbag disable instruction) as the first information to the vehicle data bus. This corresponds to the data transmission phase 502 on the vehicle data bus, when the trigger signal is encoded into a bus data frame and sent to the vehicle data bus for transmission. Simultaneously with this data transmission phase 502 on the vehicle data bus, another high-frequency pulse sequence is also transmitted in parallel via the power cable, which represents that the airbag disable switch is triggered, i.e., redundant information of the first information. Compared to the untriggered state of the airbag disable switch, when the airbag disable switch is triggered, the encoding method of the high-frequency pulse sequence transmitted on the power cable changes. In addition, it is also possible to consider using high-frequency pulse width modulation, frequency modulation, and pulse position modulation to represent different signaling content. The specific modulation method can be modulated and optimized according to the specific application requirements and communication environment.

It should be noted that while the vehicle data bus is shown as idle in FIG. 5 when there is no first information transmission, it is to be understood that this idle state is merely schematic. In other words, even if there are no specific control instructions to transmit, there are necessary system messages (such as synchronization messages) on the vehicle data bus to ensure that each node in the network remains synchronized and active.

FIGS. 6a-6e show schematic diagrams of using the method according to the present disclosure in exemplary application scenarios.

In the example shown in FIG. 6a, the vehicle data bus 3 is disconnected and the second electronic module 22 can detect that the communication status is abnormal by monitoring the communication status on the bus. At this time, the second electronic module 22 obtains the second information PADS_1 or PADS_0 from the power cable 5. In this case, the second electronic module 22 directly implements the control operation of at least one vehicle component based on the second information PADS_1 or PADS_0 transmitted on the power cable 5.

Exemplarily, the second electronic module 22 is an airbag electronic control unit, which detects that the vehicle CAN bus 3 is disconnected, and the second information PADS_0 obtained from the power cable 5 indicates that the airbag disable switch is not triggered (i.e., for example, it defaults to an activated state), so the airbag electronic control unit 22 does not change the current activation state of the airbag. For another example, if the airbag electronic control unit 22 detects that the vehicle CAN bus 3 is disconnected and at the same time the second information PADS_1 obtained from the power cable 5 indicates that the airbag disable switch is triggered (i.e., for example, an airbag disable instruction is received), the airbag electronic control unit 22 puts the relevant airbag in a disabled state.

It can be seen that if the second information PADS_1 or PADS_0 is not transmitted through the power cable 5, then in the application scenario shown in FIG. 6a, the airbag electronic control unit cannot know the switch state of the airbag disable switch at this time when the bus communication is abnormal. Therefore, for example, to ensure safety, the airbag electronic control unit 22 will automatically enter a safe state. During the safe state, the airbags remain activated by default. If the vehicle user originally wishes to disable the activated state of the airbag, such a disable instruction will not be transmitted to the airbag electronic control unit 22. By way of the redundant data stream transmitted on the power cable 5, safety-related functions can be designed to be fault-tolerant so that these electronic functions are available even in the event of a failure of the bus communication.

In the example shown in FIG. 6b, the second electronic module 22 does not determine that the communication state of the vehicle data bus 3 is abnormal. At this point, the second electronic module 22 receives the first information PAD_1 from the vehicle data bus 3 and also receives the second information PAD_1 from the power cable 5, which relates to redundant information of the first information PAD_1. In this case, the second electronic module 22 may implement a control operation on at least one vehicle component based directly on the first information PAD_1 and/or the second information PAD_1.

Exemplarily, the second electronic module 22 is an airbag electronic control unit that receives the airbag disable instruction PAD_1 from the vehicle CAN bus and the power cable 5, respectively. In response thereto, the airbag electronic control unit may place the airbag in a disabled state.

In the example shown in FIG. 6c, the second electronic module 22 does not determine that the communication state of the vehicle data bus 3 is abnormal. The second electronic module 22 does not receive the first information PAD_1 from the vehicle data bus 3 but receives the second information PAD_0 from the power cable 5, which relates to negated information of the first information PAD_1. In this case, the second electronic module 22 may implement a control operation on at least one vehicle component based directly on the second information PAD_0.

Exemplarily, the second electronic module 22 is an airbag electronic control unit, which does not receive the airbag disable instruction PAD_1 from the vehicle CAN bus but receives the untriggered state of the airbag disable switch (which corresponds to negated information of the disable instruction) PAD_0 from the power cable 5. It can be inferred from this that the user has not triggered the airbag disable switch, so the airbag electronic control unit can continue to maintain the airbag's activated state.

In the example shown in FIG. 6d, the second electronic module 22 does not determine that the communication state of the vehicle data bus 3 is abnormal. The second electronic module 22 obtains the first information PAD_1 from the vehicle data bus 3 and obtains the second information PAD_0 from the power cable 5, which relates to negated information of the first information PAD_1. For the second electronic module 22, the information content contained in the first information PAD_1 and the second information PAD_0 obtained is inconsistent, so the second electronic module 22 determines that a specific link in the vehicle communication system has a fault and thus can trigger a fault prompt in the vehicle and/or transmit a fault prompt to the backend server.

Exemplarily, the second electronic module 22 is an airbag electronic control unit, which receives the airbag disable instruction PAD_1 from the vehicle CAN bus and receives the untriggered state of the airbag disable switch (which corresponds to negated information of the disable instruction) PAD_0 from the power cable 5. The airbag electronic control unit obtains information about different switch states of the airbag disable switch through the vehicle data bus 3 and the power cable 5 and thus can determine that system function is abnormal. In this case, the airbag electronic control unit sends a control signal to the vehicle instrument or the vehicle's central control screen to light up the fault light or display a fault code.

In the example shown in FIG. 6e, the second electronic module 22 does not determine that the communication state of the vehicle data bus 3 is abnormal. The second electronic module 22 does not obtain the first information PAD_1 from the vehicle data bus 3 but obtains the second information PAD_1 from the power cable 5, which includes redundant information of the first information PAD_1. At this time, for the second electronic module 22, the information content contained in the second information PAD_1 obtained is inconsistent with the transmission status of the first information PAD_1 on the vehicle data bus 3, so the second electronic module 22 determines that a specific link in the vehicle communication system has a fault and thus can trigger a fault prompt in the vehicle and/or transmit a fault prompt to the backend server.

Exemplarily, the second electronic module 22 is an airbag electronic control unit, which does not receive the airbag disable instruction PAD_1 from the vehicle CAN bus but receives the airbag disable instruction PAD_0 from the power cable 5. The airbag electronic control unit obtains information about different switch states of the airbag disable switch through the vehicle data bus 3 and the power cable 5 and thus determines that system function is abnormal. In this case, the airbag electronic control unit sends a control signal to the vehicle instrument or the vehicle's central control screen to light up the fault light or display a fault code.

It should be understood that the method according to the various examples of the present disclosure can be achieved by computer programs/software. These software can be loaded into a working memory of the processor and used to perform the method according to various examples of the present disclosure when run.

According to another example of the present disclosure, a computer program product having a program code unit is provided, wherein the program code unit is configured to implement the method according to each example of the present disclosure when the computer program product is run on a computer or stored on a computer-readable storage medium (such as a CD-ROM). The machine-readable storage medium can be, for example, an optical storage medium or solid-state medium supplied with or as part of other hardware.

Although specific embodiments of the present disclosure have been described in detail here, they are provided solely for explanatory purposes and should not be construed as limiting the scope of the disclosure. Various substitutions, alterations, and modifications can be conceived without departing from the spirit and scope of the present disclosure.

What is claimed is:

1. A method for operating a plurality of electronic modules of a vehicle, wherein the plurality of electronic modules is connected to a vehicle data bus for communication and the plurality of electronic modules is connected to a power cable for power, the method comprising:
transmitting first information from a first electronic module of a plurality of electronic modules through a vehicle data bus to a second electronic module;
transmitting second information from the first electronic module through a power cable to the second electronic module, the second information including redundant information of the first information or negated information of the first information; and
at the second electronic module, operating the second electronic module based on the first information obtained from the vehicle data bus and/or the second information obtained from the power cable.

2. The method according to claim 1, wherein:
during transmission of the first information from the first electronic module to the second electronic module through the vehicle data bus, the second information transmitted from the first electronic module to the second electronic module through the power cable relates to redundant information of the first information; and/or
when the first information from the first electronic module is not transmitted to the second electronic module through the vehicle data bus, the second information transmitted from the first electronic module to the second electronic module through the power cable relates to the negated information of the first information.

3. The method according to claim 1, wherein the second information is transmitted from the first electronic module to the second electronic module through the power cable only when the first information includes information related to vehicle safety and/or only when the second electronic module is an electronic module related to vehicle safety.

4. The method according to claim 1, wherein operating the second electronic module based on the first information obtained from the vehicle data bus and/or the second information obtained from the power cable comprises:
at the second electronic module:
when it is determined that the communication state of the vehicle data bus is abnormal, the second electronic module implementing a control operation on at least one vehicle component based on the second information obtained from the power cable;
when it is not determined that the communication state of the vehicle data bus is abnormal:
if the first information is obtained from the vehicle data bus and the second information obtained from the power cable includes redundant information of the first information, the second electronic module implementing a control operation on at least one vehicle component based on the first information and/or the second information;
if the first information is not obtained from the vehicle data bus and the second information obtained from the power cable includes negated information of the first information, the second electronic module implementing a control operation on at least one vehicle component based on the second information;
if the first information is obtained from the vehicle data bus and the second information obtained from the power cable includes negated information of the first information, the second electronic module triggering a fault prompt in the vehicle and/or transmitting a fault prompt to the background server; and/or
if the first information is not obtained from the vehicle data bus and the second information obtained from the power cable includes redundant information of the first information, the second electronic module triggering a fault prompt in the vehicle and/or transmitting a fault prompt to the background server.

5. The method according to claim 1, wherein the first electronic module is a display electronic control unit of the vehicle, the second electronic module is an airbag electronic control unit of the vehicle, the first information includes whether the airbag disable switch is triggered, and the second information includes whether the airbag disable switch is triggered or not triggered.

6. The method according to claim 1, wherein the method further comprises:
transmitting third information from the first electronic module to the second electronic module through the power cable, the third information relating to information of a different type than the first information.

7. The method according to claim 1, wherein:
the first electronic module converts the second information into a communication signal carrying the second information via a modulation/encoding operation, couples the communication signal with the power supply signal on the power cable, and loads the communication signal on the power cable; and/or
wherein the second electronic module separates the communication signal carrying the second information from the power supply signal on the power cable by a decoupling operation and converts the communication signal into the second information by a demodulation/decoding operation.

8. The method according to claim 1, wherein:
when transmitting the second information through the power cable, the frequency of the communication signal carrying the second information to be loaded onto the power cable is set to be higher than the frequency of the power supply signal on the power cable by a predetermined frequency interval, wherein the communication signal is a high-frequency pulse current signal.

9. The method according to claim 1, further comprising:
transmitting fourth information through the power cable from the first electronic module to a third electronic module of the plurality of electronic modules, wherein the communication address of the second electronic module is transmitted via the power cable in conjunction with the second information and the communication address of the third electronic module is transmitted via the power cable in conjunction with the fourth information.

10. An in-vehicle communication system, comprising:
a vehicle data bus;
a power cable; and
a plurality of electronic modules operating according to the method of claim 1.

11. The in-vehicle communication system according to claim 10, wherein:
the plurality of electronic modules comprises at least a first electronic module that includes a power cable sending unit and a second electronic module that includes a power cable receiving unit, and
the power cable sending unit is configured to load a communication signal onto the power cable and the power cable receiving unit is configured to receive a communication signal from the power cable.

12. The in-vehicle communication system according to claim 11, wherein:
the power cable sending unit comprises (i) a modulation/encoding unit configured to convert the second information into a communication signal, and (ii) a coupling unit configured to couple the communication signal with the power supply signal on the power cable and load the signal onto the power cable for transmission, and/or
the power cable receiving unit comprises (i) a decoupling unit configured to separate a communication signal from a power supply signal on a power cable, and (ii) a demodulating/decoding unit configured to convert the communication signal into the second information.

13. A computer program product having a program code unit configured to cause the computer to implement the method according to claim 1 when the computer program product is running on a computer or stored on a computer-readable storage medium.
